(19) United States
(12) Patent Application Publication
(10) Pub. No.: US 2017/0017534 A1
(43) Pub. Date: Jan. 19, 2017

(54) METHOD AND APPARATUS OF BACK LOBE CORRECTION TO ANTENNA TEMPERATURE FOR EARTH-OBSERVING MICROWAVE INSTRUMENTS

(71) Applicant: U.S.A. as represented by the Administrator of the National Aeronautics and Space Administration, Washington, DC (US)

(72) Inventor: Giovanni De Amici, Crofton, MD (US)

(21) Appl. No.: 14/800,748

(22) Filed: Jul. 16, 2015

(51) Int. Cl. G06F 11/00

(52) U.S. Cl. CPC G06F 11/00

(57) ABSTRACT

The present invention relates to a method and apparatus which corrects antenna noise temperature in antenna back lobes, for earth-observing microwave instruments on satellites in orbit, to counter signal contamination from celestial bodies. The antenna back lobe signal correction is computer-program-modeled with only a few static and only a few dynamic inputs, and for a given set of parameters (i.e., orbital altitude, pointing characteristics (e.g., nadir or cross-scanning or conical-scanning), frequency selectivity of the receiver/detector) produces a few output files which are then combined by the program to predict the back lobe signal correction which is to be applied.

### BACKGROUND OF THE INVENTION

1. Field of the Invention

The present invention relates to a method and apparatus of back lobe correction to antenna temperature for earth-observing microwave instruments to counter extra-terrestrial signal contamination.

2. Description of the Related Art

Microwave antennas deployed for space-borne instruments such as radiometers, which detect electromagnetic radiation, are diffraction-limited, with typical beam efficiency which characterizes the antennas' performance, of about 90%, and which provide relatively poor resistance to radiation from celestial bodies (i.e., Moon, Sun, Galaxy), when they are at the side or back of the radiometer.

Traditionally, this signal contamination, which increases antenna temperature, has been removed by using computer programs with algorithms which are run multiple times (i.e., multiple data files), and which represent the relative position of the spacecraft and the celestial sources throughout the mission lifetime. The program runs (i.e., data files) are dynamic with time, and this approach is time consuming as it introduces an additional source of uncertainty when maps calculated for one orbit at the beginning of the mission are applied to the same orbit many months after launch when positional data may have changed, and thus, may need to be recalculated if, for example, the equatorial crossing time differs from the planned one.

Thus, a method and apparatus for back lobe correction to antenna temperature for earth-absorbing microwave instruments for extra-terrestrial signal contamination is needed.

### SUMMARY OF THE INVENTION

The present invention relates to a method and apparatus of back lobe correction to antenna temperature for earth-observing microwave instruments for extra-terrestrial signal contamination. In one embodiment, the present invention relates to a computer program which implements a back lobe correction that is modeled with only a handful of static data files which are dependent only upon a few “a priori” parameters: 1) the ephemeris of the Sun and the Moon, and the map of Galactic emission, 2) the gain pattern of the instrument's antenna, and 3) the altitude of the orbit.

In particular, the program of the present invention takes a few static and a couple of dynamic (time dependent) inputs, and for a given set of parameters (i.e., orbital altitude, pointing characteristics (e.g., nadir or cross-scanning or conical-scanning), frequency selectivity of the receiver/detector) produces a few output files which are then combined to predict the back lobe signal correction which is to be applied.

In the present invention, all outputs can be pre-calculated, leaving only a simple sum to be performed by the program when the last variable (i.e., the time-dependent pointing) is known. However, in the present invention, those outputs only need to be a few: one for the Sun, one for the Moon and a handful for the Galaxy. How large is the handful depends upon the desired accuracy. A single file, obtained by averaging together 10 output files for different around-nadir angles, yields an error in the correction of up to 0.1 K. Using all 10 outputs and interpolating between adjacent ones reduces the uncertainty for the Galactic correction to a few mK level.

The secular variation of the correction is controlled by the pointing of the antenna main beam in (Right Ascension (R.A.), declination (dec)) coordinates, and which is easily calculated by the program at any moment in time from the spacecraft and instrument ephemeris. Under ideal conditions of a nadir-looking instrument, a circularly symmetric antenna gain pattern and a circular low-ellipticity orbit of almost-constant altitude, less than 8 program runs (or output data files) are needed.

Under conditions which are typical for most Earth-observing satellites, less than 10 output static program runs (or data files) would be needed by the program to correct for radiation contamination regarding microwave antennas during the entire lifespan of an orbital mission.

In one embodiment, a method of correcting an antenna noise temperature in an antenna on earth-observing microwave instruments, includes: providing at least one processor executing program code to implement a correction to the antenna noise temperature in the antenna, the program code including the steps of: calculating a convolution of a signal from a Galaxy with a full sky map of a pattern of a beam from the antenna; subtracting a part of the Galaxy which is covered by a Sun; subtracting a part of said Galaxy which is covered by a Moon; and subtracting a part of said Galaxy which is covered by an Earth.

In one embodiment, an algorithm which expresses the correction to the antenna noise temperature in the antenna is given by:

$$Effective Galaxy ( RA , dec , {RA}_{sun} , {dec}_{sun} , {RA}_{moon} , {dec}_{moon} , {RA}_{earth} , {dec}_{earth} , α , β ) = \int {Map}_{galaxy} ( θ , ϕ ) * {Gain}_{beam} ( α , β ) d θ d ϕ - {\int }_{{Sun}_{solid {angle}_{}}}^{} {Map}_{galaxy} ( θ , ϕ ) * ( \int {Gain}_{beam} ( α , β ) * {Sun}_{position} ( α , β ) d α d β ) d θ d ϕ - {\int }_{{Moon}_{solid {angle}_{}}}^{} {Map}_{galaxy} ( θ , ϕ ) * ( \int {Gain}_{beam} ( α , β ) * {Moon}_{position} ( α , β ) d α d β ) d θ d ϕ - {\int }_{{Earth}_{solid {angle}_{}}}^{} {Map}_{galaxy} ( θ , ϕ ) * ( \int {Gain}_{beam} ( α , β ) * {Earth}_{position} ( α , β ) d α d β ) d θ d ϕ$$

where (θ, φ) are in celestial coordinates, and (α, β) are in antenna-centered altitude-azimuth (alt-az) coordinates.

In one embodiment, the method includes calculating contributions of the Galaxy, the Sun, and the Moon, as a function of time.

In one embodiment, the method further includes: pre-calculating a position of the Sun with respect to the beam of the antenna and a gain-weighted signal from a part of the sky covered by the Sun, in one static file.

In one embodiment, the method further includes pre-calculating a position of the Moon with respect to the beam of the antenna and a gain-weighted signal from a part of the sky covered by the Moon, in a second static file.

In one embodiment, the method further includes pre-calculating a gain-weighted signal from a part of the sky which is covered by the Earth, in a third static file.

In one embodiment, the method further includes determining whether the Sun and/or the Moon are in eclipse behind the Earth.

In one embodiment, the method further includes: obtaining a pointing of the antenna in celestial coordinates; using the pointing together with contributions from the first static file, second static file, and third static file, to create a two-dimensional array of the convolution of a Galactic contribution which is valid for each day of a year.

In one embodiment, the celestial coordinates of the pointing of the antenna is obtained from a lookup table.

In one embodiment, the position of the Sun and the position of the Moon are celestial coordinates obtained from a lookup table.

In one embodiment, a gain response of the antenna is obtained from a lookup table.

In one embodiment, a position of the Earth is in celestial coordinates, and a clock angle of the Earth, are obtained from at least one lookup table.

In one embodiment, a data volume is reduced by a factor about 100, and said correction is modeled with no more than said three static files for contamination in side-and back-lobes of an Earth-pointing antenna.

In one embodiment, each lookup table is pre-calculated based on the antenna gain response and an orbital altitude which does not require re-calculation of the lookup tables if a timing of an orbit is modified.

In one embodiment, with a nadir-looking instrument, a circularly symmetric antenna gain pattern and a circular low-elliptic orbit of almost-constant altitude, 8 or less static data files are required for the correction during a lifespan of an orbital mission.

In one embodiment, a secular variation of the correction is controlled by the pointing of the beam of the antenna, and calculated at any moment in time from a spacecraft and a microwave instrument ephemeris.

In one embodiment, less than 10 static files are required for the correction during a lifespan of an orbital mission.

In one embodiment, a system which corrects an antenna noise temperature in an antenna on earth-observing microwave instruments, the system includes: at least one processor executing program code to implement a correction to the antenna noise temperature in an antenna, the program code including the steps of: calculating a convolution of a signal from a Galaxy with a full sky map of a pattern of a beam from the antenna; subtracting a part of the Galaxy which is covered by a Sun; subtracting a part of the Galaxy which is covered by a Moon; and subtracting a part of the Galaxy which is covered by the Earth.

In one embodiment, a non-transitory computer-accessible medium having a program which contains executable instructions to implement a correction to the antenna noise temperature in an antenna on earth-observing microwave instruments, the program comprising the steps of: calculating a convolution of a signal from a Galaxy with a full sky map of a pattern of a beam from the antenna; subtracting a part of the Galaxy which is covered by a Sun; subtracting a part of the Galaxy which is covered by a Moon; and subtracting a part of the Galaxy which is covered by the Earth.

Thus has been outlined, some features consistent with the present invention in order that the detailed description thereof that follows may be better understood, and in order that the present contribution to the art may be better appreciated. There are, of course, additional features consistent with the present invention that will be described below and which will form the subject matter of the claims appended hereto.

In this respect, before explaining at least one embodiment consistent with the present invention in detail, it is to be understood that the invention is not limited in its application to the details of construction and to the arrangements of the components set forth in the following description or illustrated in the drawings. Methods and apparatuses consistent with the present invention are capable of other embodiments and of being practiced and carried out in various ways. Also, it is to be understood that the phraseology and terminology employed herein, as well as the abstract included below, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the methods and apparatuses consistent with the present invention.

### BRIEF DESCRIPTION OF THE DRAWING

FIG. 1 is an exemplary arrangement of a general-purpose computing device, consistent with the present invention.

FIG. 2 is a flow chart showing the major steps in achieving the back lobe signal correction according to one embodiment consistent with the present invention.

DESCRIPTION OF THE INVENTION

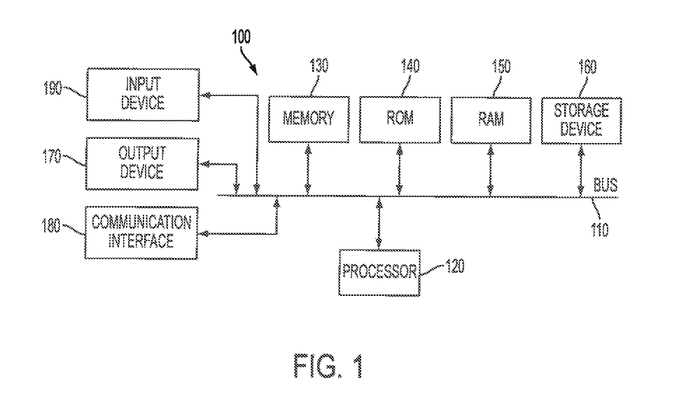

With reference to FIG. 1, an exemplary system includes a general-purpose computing device 100, including a processing unit (CPU) 120 and a system bus 110 that couples various system components including the system memory, such as read-only memory (ROM) 140 and random access memory (RAM) 150 to the processing unit 120. Other system memory 130 may be available for use as well. It can be appreciated that the invention may operate on a computing device with more than one CPU 120 or on a group or cluster of computing devices networked together to provide greater processing capability. A processing unit 120 can include a general purpose CPU controlled by software as well as a special-purpose processor. An Intel® Xeon LV L7345 processor is an example of a general purpose CPU which is controlled by software. Particular functionality may also be built into the design of a separate computer chip. An STMicroelectronics STA013 processor is an example of a special-purpose processor which decodes MP3 audio files. Of course, a processing unit includes any general purpose CPU and a module configured to control the CPU as well as a special-purpose processor where software is effectively incorporated into the actual processor design. A processing unit may essentially be a completely self-contained computing system, containing multiple cores or CPUs, a bus, memory controller, cache, etc. A multi-core processing unit may be symmetric or asymmetric.

The system bus 110 may be any of several types of bus structures including a memory bus or memory controller, a peripheral bus, and a local bus using any of a variety of bus architectures. A basic input/output (BIOS) stored in ROM 140 or the like, may provide the basic routine that helps to transfer information between elements within the computing device 100, such as during start-up. The computing device 100 further includes storage devices such as a hard disk drive 160, a magnetic disk drive, an optical disk drive, tape drive or the like. The storage device 160 is connected to the system bus 110 by a drive interface. The drives and the associated computer readable media provide nonvolatile storage of computer readable instructions, data structures, program modules and other data for the computing device 100. In one aspect, a hardware module that performs a particular function includes the software component stored in a tangible computer-readable medium in connection with the necessary hardware components, such as the CPU, bus, display, and so forth, to carry out the function. The basic components are known to those of skill in the art and appropriate variations are contemplated depending on the type of device, such as whether the device is a small, handheld computing device, a desktop computer, or a computer server.

Although the exemplary environment described herein may employ a hard disk, it should be appreciated by those skilled in the art that other types of computer-readable media which can store data that are accessible by a computer, such as magnetic cassettes, flash memory cards, digital versatile disks, cartridges, random access memories (RAMs), read only memory (ROM), a cable or wireless signal containing a bit stream and the like, may also be used in the exemplary operating environment.

To enable user interaction with the computing device 100, an input device 190 represents any number of input mechanisms, such as a microphone for speech, a touch-sensitive screen for gesture or graphical input, keyboard, mouse, motion input, speech and so forth. The input may be used by the presenter to indicate the beginning of a speech search query. The device output 170 can also be one or more of a number of output mechanisms known to those of skill in the art. In some instances, multimodal systems enable a user to provide multiple types of input to communicate with the computing device 100. The communications interface 180 generally governs and manages the user input and system output. There is no restriction on the invention operating on any particular hardware arrangement and therefore the basic features here may easily be substituted for improved hardware or firmware arrangements as they are developed.

For clarity of explanation, the illustrative system embodiment is presented as comprising individual functional blocks (including functional blocks labeled as a “processor”). The functions these blocks represent may be provided through the use of either shared or dedicated hardware, including, but not limited to, hardware capable of executing software and hardware, such as a processor, that is purpose-built to operate as an equivalent to software executing on a general purpose processor. For example the functions of one or more processors presented in FIG. 1 may be provided by a single shared processor or multiple processors. (Use of the term “processor” should not be construed to refer exclusively to hardware capable of executing software.) Illustrative embodiments may comprise microprocessor and/or digital signal processor (DSP) hardware, read-only memory (ROM) for storing software performing the operations discussed below, and random access memory (RAM) for storing results. Very large scale integration (VLSI) hardware embodiments, as well as custom VLSI circuitry in combination with a general purpose DSP circuit, may also be provided.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits.

According to one embodiment, the present invention may be implemented using software applications that reside in a client and/or server environment. According to another embodiment, the present invention may be implemented using software applications that reside in a distributed system over a computerized network and across a number of client computer systems. Thus, in the present invention, a particular operation may be performed either at the client computer, the server, or both. While the system of the present invention may be described as performing certain functions, one of ordinary skill in the art will readily understand that the program may perform the function rather than the entity of the system itself. According to one embodiment of the invention, the program that runs the system 100 may include separate programs having code that performs desired operations. According to one embodiment, the program that runs the system 100 may include a plurality of modules that perform sub-operations of an operation, or may be part of a single module of a larger program that provides the operation. Further, although the above-described features and processing operations may be realized by dedicated hardware, or may be realized as programs having code instructions that are executed on data processing units, it is further possible that parts of the above sequence of operations may be carried out in hardware, whereas other of the above processing operations may be carried out using software.

According to one embodiment of the invention, the server may include a single unit or may include a distributed system having a plurality of servers or data processing units. The server(s) may be shared by multiple users in direct or indirect connection to each other. The server(s) may be coupled to a communication link that is preferably adapted to communicate with a plurality of client computers. Although the above physical architecture has been described as client-side or server-side components, one of ordinary skill in the art will appreciate that the components of the physical architecture may be located in either client or server, or in a distributed environment.

The underlying technology allows for replication to various other sites. Each new site may maintain communication with its neighbors so that in the event of a catastrophic failure, one or more servers may continue to keep the applications running, and allow the system to load-balance the application geographically as required.

The present invention relates to a method and apparatus which corrects antenna noise temperature in antenna back lobes, for earth-observing microwave instruments, such as radiometers, radars, and scatterometers, on satellites in orbit, to counter signal contamination from celestial bodies.

Microwave antennas deployed for space-borne instruments on satellites in orbit, are susceptible to radiation from celestial bodies (i.e., Moon, Sun, Galaxy), when they are at the side or back of the instrument. In a directional antenna, the radio waves emitted in the opposite direction from the main lobe is termed the “back lobe”, and extraterrestrial signal contamination (from the celestial bodies) of the back lobe, increases antenna noise temperature, which affects the performance of the microwave instrument, lowering the instrument's sensitivity to the desired, earth-generated geophysical signals.

The present invention is related to a computer program which is used to correct the back lobe antenna noise temperature for microwave instruments in orbit. In one embodiment, the antenna back lobe signal correction is computer-program-modeled with only a few “static” data files (which do not change based on user input, vs. “dynamic” data files which are time-dependent and used conventionally, and which require processing by an application).

Essentially, the program of the present invention takes a few static and only a few dynamic (time dependent) inputs, and for a given set of parameters (i.e., orbital altitude, pointing characteristics (e.g., nadir or cross-scanning or conical-scanning), frequency selectivity of the receiver/detector) produces a few output files which are then combined by the program to predict the back lobe signal correction which is to be applied.

In the present invention, all outputs can be pre-calculated, leaving only a simple sum to be performed by the program when the last variable (i.e., the time-dependent pointing) is known. However, in the present invention, those outputs only need to be a few: one for the Sun, one for the Moon and a few for the Galaxy. How large is the amount for the Galaxy depends upon the desired accuracy. A single file—obtained by the program averaging together 10 output files for different around-nadir angles—yields an error in the back lobe signal correction of up to 0.1 Kelvin (K). By using all 10 outputs and interpolating between adjacent ones, the program reduces the uncertainty for the Galactic correction to a few mK level.

More specifically, the spatial response function of microwave antennas, which measures the response of the microwave instrument to radiation input along a single projection vector, is diffraction-limited, and requires correction for multiple interfering signals. For example, the Milky Way Galaxy is a diffuse source, which is highly anisotropic (i.e., directionally dependent). The Milky Way galaxy is a strong source when observed, for example, at boresight (i.e., axis of maximum gain of a directional antenna), with a narrow-beam antenna from an exemplary 6-meter class off-axis parabolic antenna, for a 0.1 degree (deg) resolution, with the peak of brightness being at 1.4 GigaHertz (GHz) at over 212 Kelvin (K). Wide beam observations reduce the peak-to-peak signal noise variation, but not the anisotropy.

Conventionally, one would calculate the position of the Sun and the Moon and the Earth with respect to the satellite and the Galactic background as a function of time, creating a function of multiple variables each one with a different dependency upon the time of observation and spacecraft location. The result is a large set of files (typically 366 files, one for each day of the year), indexed by the spherical polar coordinates Right Ascension (RA) and declination (dec) of the boresight pointing, the latitude of the spacecraft's nadir, the direction of the orbital path, and the pointing of the instrument around the nadir. If the satellite's orbit or the instrument's pointing do not match prediction, all calculations must be repeated with data entries corrected. If the satellite's orbit or the instrument's pointing change during the mission, all calculations must be repeated.

In one embodiment of the present invention, to obtain the back lobe correction for the antenna signal, the program models the measured radiance as a simple sum of elements independent from each other, greatly simplifying the analysis. These elements are: the convolution (i.e., a function derived from two given functions by integration that expresses how the shape of one is modified by the other) of the Galactic signal (e.g., the Galactic Emission Map (GEM—which provides the spatial distribution and absolute intensity in the radio and microwave spectrum of radiation emitted by the Milky Way Galaxy and by the unresolved blend of external galaxies) at 1420 MHz), with the full sky (4π steradiant) map of the antenna beam pattern (as derived from pre-launch measurements); a term describing the part of the Galaxy which is covered by the Sun; a term describing the part of the Galaxy which is covered by the Moon; and a term describing the part of the Galaxy which is covered by the Earth.

Specifically, in order to correct the measured signal from the antenna, the program combines the contribution from the Galaxy, the Sun, and the Moon, as a function of time.

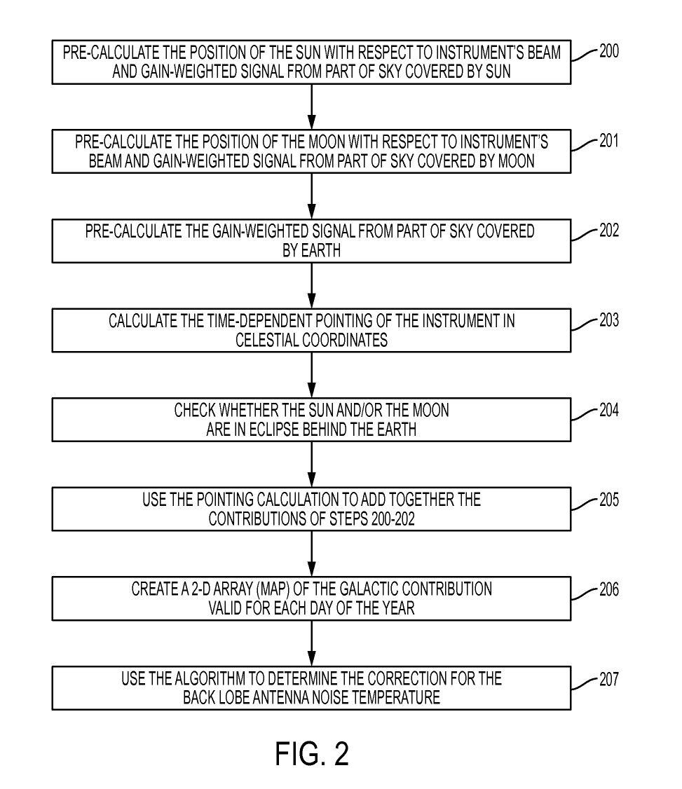

In particular, in step 200 (see FIG. 2), the program pre-calculates the position of the Sun with respect to the instrument's beam and the gain-weighted signal from the part of the sky covered by the Sun (first static file).

In step 201, the program pre-calculates the position of the Moon with respect to the instrument's beam and the gain-weighted signal from the part of the sky covered by the Moon (second static file).

In step 202, the program pre-calculates the gain-weighted signal from the part of the sky covered by the Earth (third static file—really as many as 10 static files, indexed by around-nadir angle).

In step 203, the program calculates the time-dependent pointing of the instrument in celestial coordinates.

In step 204, the program checks whether the Sun and/or the Moon are in eclipse behind the Earth, and therefore not visible from the instrument.

In step 205, the program uses the pointing calculated in step 203 to add together the contributions from the different static files (steps 200-202).

In step 206, the program creates a two-dimensional array (map) of the Galactic contribution which is valid for each day of the year, and does not need to be indexed by the latitude of the spacecraft's nadir, the direction of the orbital path. Only the pointing of the instrument around the nadir remains to be considered.

This is a slow-varying effect, which only requires a few data runs (files) to be fully modeled. In one embodiment, the entire variation caused by the around-nadir pointing is accounted with just 10 files. These files do not need to be re-calculated if the equatorial crossing time of the satellite or its pointing were to change since they are only indexed by the (RA, dec) pointing of the antenna beam and the round-nadir angle.

In step 207, the program uses the following algorithm to determine the correction for the back lobe antenna noise temperature, using the above data:

$$Effective Galaxy ( RA , dec , {RA}_{sun} , {dec}_{sun} , {RA}_{moon} , {dec}_{moon} , {RA}_{earth} , {dec}_{earth} , α , β ) = \int {Map}_{galaxy} ( θ , ϕ ) * {Gain}_{beam} ( α , β ) d θ d ϕ - {\int }_{{Sun}_{solid {angle}_{}}}^{} {Map}_{galaxy} ( θ , ϕ ) * ( \int {Gain}_{beam} ( α , β ) * {Sun}_{position} ( α , β ) d α d β ) d θ d ϕ - {\int }_{{Moon}_{solid {angle}_{}}}^{} {Map}_{galaxy} ( θ , ϕ ) * ( \int {Gain}_{beam} ( α , β ) * {Moon}_{position} ( α , β ) d α d β ) d θ d ϕ - {\int }_{{Earth}_{solid {angle}_{}}}^{} {Map}_{galaxy} ( θ , ϕ ) * ( \int {Gain}_{beam} ( α , β ) * {Earth}_{position} ( α , β ) d α d β ) d θ d ϕ$$

where (θ, φ) are in celestial coordinates, and (α, β) are in antenna-centered altitude-azimuth (alt-az) coordinates.

For the ephemeris (look-up tables (LUTs) which provide positions of objects in the sky at given times), each set of LUTs (one table per day of the year) occupies a large volume, assuming single precision storage (32 bit), 0.25 deg resolution, and full-sky coverage. One set of tables requires several Gbytes per radiometric channel per iteration by the program.

Conventionally, every time an event (for example, change in orbit due to debris, or inaccuracy in degree of pointing) requires that the LUTs are recalculated by the program, more data storage must be set aside as the now-obsolete tables should be retained in archival format for possible future reprocessing.

However, in the present invention, as noted above, the algorithm requires as inputs simply: celestial coordinates of the pointing of the instrument's antenna (1 LUT or file); celestial coordinates of the position of the Sun and of the Moon as seen by the instrument's antenna (1 LUT or file); the gain response of the antenna (1 LUT or file); and celestial coordinates and clock angle of the Earth as seen by the instrument's antenna (potentially 360/HPWBW LUTs or files; it will be shown that one LUT is sufficient for most applications). The data volume with respect to the traditional approach is reduced by a factor ˜100.

It is noted that the Sun and Moon have a small angular size and can be easily modeled and subtracted by the program to achieve the desired back lobe correction. The Earth Shadow is convolved with the galactic brightness at all possible pointing directions. This leads to an estimate of the signal left to contaminate the telluric brightness temperature, where the skymap minus the earth shadow equals the remaining back lobe contamination.

Further, double-difference maps yield small signatures. In one example, the largest difference (in K) between any two correction maps over a 360 deg orientation change is 0.010753. Small differences suggest that a single averaged map well represents the ensemble. Small uncertainties are introduced when the averaged map is used (i.e. 10⁻³ K).

In one embodiment, the program of the present invention can be applied to a circularly asymmetric antenna gain pattern, with the contribution of the Sun, Moon, and Galaxy as reflected from the Earth surface into the main beam of the instrument's antenna.

Accordingly, advantageously, the program for the antenna back lobe signal correction of the present invention requires only a few “a priori” parameters: 1) the ephemeris (look-up tables (LUTs) which provide positions of objects in the sky at given times) of the Sun and the Moon, and the Galactic Emission Map; 2) the gain pattern of the instrument's antenna; and 3) the altitude of the orbit.

The secular variation of the correction is controlled by the pointing of the antenna main beam (R.A., dec), and which is easily calculated at any moment in time from the spacecraft and instrument ephemeris. Under ideal conditions of a nadir-looking instrument, a circularly symmetric antenna gain pattern and a circular low-elliptic orbit of almost-constant altitude, less than eight (8) computer runs (i.e., output data files) are needed. Further, under conditions which are typical for most Earth-observing satellites, less than 10 static output data files would be needed by the program of the present invention, to correct for radiation contamination regarding microwave antennas during the entire lifespan of an orbital mission.

The fact that less than 10 data files are needed by the program (i.e., 10 times, once every 36 degrees azimuth) means that the accuracy is high enough to reduce uncertainty to 0.1 K. If a program run is performed every 20 degrees, then more data files would be required, reducing uncertainty.

Accordingly, the signal contamination in the side-and back-lobes of an Earth-pointing instrument from the Sun and the Moon can be computer-modeled using the program of the present invention, with a few (i.e., three) static input files; one each for the celestial objects and one for the antenna gain pattern. The Milky Way galaxy can be similarly modeled by the program with just one static file; the uncertainty introduced by this process is about 10 mK, which is negligible after is root-sum-squared with the other uncertainties.

The program's use of a few static files offers the advantages that: 1) it reduces the need for storage space by a factor greater than 100; 2) it allows the user to process the data on smaller, less powerful computers (e.g., on tactical field terminals); 3) it allows the user to pursue products with finer spatial resolution; and 4) it allows the LUTs to be pre-calculated based on the antenna gain pattern and the orbital altitude and it does not require recalculation of the LUTs if the timing of the orbit is modified (e.g., by a launch delay).

It is noted that the contribution from the highly isotropic constant microwave background radiation (CMBR) (dipole amplitude is 3 mK, higher poles are two order-of-magnitude smaller) can be calculated by multiplying the integrated antenna gain over the solid angle not covered by the Earth (in one embodiment about 0.015) times the CMBR brightness temperature at 1.4 GH (2.72 K). The signal is small (about 42 mK) and constant for all pointing directions.

Thus, the program of the present invention provides a novel and advantageous method of removing signal contamination which increases antenna temperature, without using dynamic program runs, which saves time and decreases uncertainty.

Embodiments within the scope of the present invention may also include computer-readable media for carrying or having computer-executable instructions or data structures stored thereon. Such computer-readable media can be any available media that can be accessed by a general purpose or special purpose computer, including the functional design of any special purpose processor as discussed above. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, data structures, and the functions inherent in the design of special-purpose processors, etc., that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those of skill in the art will appreciate that other embodiments of the invention may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

It should be emphasized that the above-described embodiments of the invention are merely possible examples of implementations set forth for a clear understanding of the principles of the invention. Variations and modifications may be made to the above-described embodiments of the invention without departing from the spirit and principles of the invention. All such modifications and variations are intended to be included herein within the scope of the invention and protected by the following claims.

What is claimed is:

1. A method of correcting an antenna noise temperature in an antenna on earth-observing microwave instruments, the method comprising:
providing at least one processor executing program code to implement a correction to the antenna noise temperature in the antenna, said program code including the steps of:
calculating a convolution of a signal from a Galaxy with a full sky map of a pattern of a beam from the antenna;
subtracting a part of said Galaxy which is covered by a Sun;
subtracting a part of said Galaxy which is covered by a Moon; and
subtracting a part of said Galaxy which is covered by an Earth.

2. The method of claim 1, wherein an algorithm which expresses said correction to the antenna noise temperature in the antenna is:
$$Effective Galaxy ( RA , dec , {RA}_{sun} , {dec}_{sun} , {RA}_{moon} , {dec}_{moon} , {RA}_{earth} , {dec}_{earth} , α , β ) = \int {Map}_{galaxy} ( θ , ϕ ) * {Gain}_{beam} ( α , β ) d θ d ϕ - {\int }_{{Sun}_{solid {angle}_{}}}^{} {Map}_{galaxy} ( θ , ϕ ) * ( \int {Gain}_{beam} ( α , β ) * {Sun}_{position} ( α , β ) d α d β ) d θ d ϕ - {\int }_{{Moon}_{solid {angle}_{}}}^{} {Map}_{galaxy} ( θ , ϕ ) * ( \int {Gain}_{beam} ( α , β ) * {Moon}_{position} ( α , β ) d α d β ) d θ d ϕ - {\int }_{{Earth}_{solid {angle}_{}}}^{} {Map}_{galaxy} ( θ , ϕ ) * ( \int {Gain}_{beam} ( α , β ) * {Earth}_{position} ( α , β ) d α d β ) d θ d ϕ$$
where (θ, φ) are in celestial coordinates, and (α, β) are in antenna-centered altitude-azimuth (alt-az) coordinates.

3. The method of claim 2, further comprising:
calculating said contributions of said Galaxy, said Sun, and said Moon, as a function of time.

4. The method of claim 3, further comprising:
pre-calculating a position of said Sun with respect to said beam of said antenna and a gain-weighted signal from said part of said sky covered by said Sun, in one static file.
pre-calculating a position of said Moon with respect to said beam of said antenna and a gain-weighted signal from said part of said sky covered by said Moon, in a second static file;
pre-calculating a gain-weighted signal from said part of said sky which is covered by said Earth, in a third static file; and
determining whether said Sun and/or said Moon are in eclipse behind said Earth.

5. The method of claim 4, further comprising:
obtaining a pointing of said antenna in celestial coordinates;
using said pointing together with contributions from said first static file, second static file, and third static file, to create a two-dimensional array of said convolution of a Galactic contribution which is valid for each day of a year.

6. The method of claim 5, wherein said celestial coordinates of said pointing of said antenna is obtained from a lookup table.

7. The method of claim 6, wherein said position of said Sun and said position of said Moon are celestial coordinates obtained from a lookup table.

8. The method of claim 7, wherein a gain response of said antenna is obtained from a lookup table.

9. The method of claim 7, wherein a position of said Earth in celestial coordinates, and a clock angle of said Earth, are obtained from at least one lookup table.

10. The method of claim 9, wherein a data volume is reduced by a factor about 100, and said correction is modeled with no more than said three static files for contamination in side-and back-lobes of an Earth-pointing antenna.

11. The method of claim 10, wherein each said lookup table is pre-calculated based on said antenna gain response and an orbital altitude which does not require re-calculation of said lookup tables if a timing of an orbit is modified.

12. The method of claim 11, wherein with a nadir-looking instrument, a circularly symmetric antenna gain pattern and a circular low-elliptic orbit of almost-constant altitude, 8 or less static data files are required for said correction during a lifespan of an orbital mission.

13. The method of claim 11, wherein a secular variation of said correction is controlled by said pointing of said beam of said antenna, and calculated at any moment in time from a spacecraft and a microwave instrument ephemeris.

14. The method of claim 11, wherein less than 10 static files are required for said correction during a lifespan of an orbital mission.

15. A system which corrects an antenna noise temperature in an antenna on earth-observing microwave instruments, the system comprising:
at least one processor executing program code to implement a correction to the antenna noise temperature in an antenna, said program code including the steps of:
calculating a convolution of a signal from a Galaxy with a full sky map of a pattern of a beam from the antenna;
subtracting a part of said Galaxy which is covered by a Sun;
subtracting a part of said Galaxy which is covered by a Moon; and
subtracting a part of said Galaxy which is covered by an Earth.

16. A non-transitory computer-accessible medium having a program which contains executable instructions to implement a correction to the antenna noise temperature in an antenna on earth-observing microwave instruments, the program comprising the steps of:
calculating a convolution of a signal from a Galaxy with a full sky map of a pattern of a beam from the antenna;
subtracting a part of said Galaxy which is covered by a Sun;
subtracting a part of said Galaxy which is covered by a Moon; and
subtracting a part of said Galaxy which is covered by an Earth.
